(19) United States
(12) Patent Application Publication
(10) Pub. No.: US 2018/0223735 A1
(43) Pub. Date: Aug. 9, 2018

(54) PRE-SWIRLER FOR GAS TURBINE

(71) Applicant: DOOSAN HEAVY INDUSTRIES & CONSTRUCTION CO., LTD., Changwon-si, (KR)

(72) Inventor: Dong Hwa Kim, Seoul (KR)

(21) Appl. No.: 15/888,085

(22) Filed: Feb. 5, 2018

(30) Foreign Application Priority Data
Feb. 7, 2017 (KR) 10-2017-0016989

(51) Int. Cl. F02C 7/18; F01D 25/12; F15D 1/00

(52) U.S. Cl. CPC F02C 7/18; F15D 1/0015; F01D 25/12

(57) ABSTRACT

Disclosed is a pre-swirler for a gas turbine. A pre-swirler for a gas turbine according to an embodiment of the present invention including an auxiliary vane between main vanes disposed along a circumferential direction of a pre-swirler housing of a gas turbine to promote stable movement of cooling air.

### CROSS-REFERENCE TO RELATED APPLICATION(S)

This application claims priority to Korean Patent Application No. 10-2017-0016989, filed on Feb. 7, 2017 the disclosure of which is incorporated herein by reference in its entirety.

### BACKGROUND OF THE INVENTION

### Field of the Invention

Exemplary embodiments of the present invention relate to a pre-swirler, and more particularly, to a pre-swirler for a gas turbine, including an auxiliary vane between main vanes disposed along a circumferential direction of a pre-swirler housing of a gas turbine to promote stable movement of cooling air.

### Description of the Related Art

In general, as fuel is combusted in a combustion chamber, high temperature combustion gas is generated in a gas turbine. The high-temperature and high-pressure gas expands while flowing along a stator vane row and a turbine rotor blade row that are alternately disposed in a turbine portion, and available power is generated using energy resulting from the expansion.

The initial gas flow of the stator vane row and the blade row is generally maintained at high temperature of 1000° C. or higher. The blade and the vane are vulnerable to the high-temperature gas flow, thus are cooled by cooling air compressed at the upstream side in an engine and then flowing to a turbine member.

In the gas turbine operated as described above, transporting cooling air from an air gap at which an inside of the stator is fixed to a rotor assembly to disperse the cooling air to an inner side of the rotor blade is an important problem. To achieve the purpose as described above, conventionally, an on-board injection has been used.

In particular, compressed air discharged from a compressor flows in a circumferential direction after passing through the on-board injection.

A swirling component is given to the compressed air passing through the on-board injection, such that the cooling air flows to be discharged to the rotating turbine assembly in a tangential direction. An amount and a direction of the cooling air affect effectiveness of cooling capacity of the cooling air and overall performance of the engine.

When an amount of air is too small, the turbine blade is overheated, but when air is excessively supplied, combustion efficiency deteriorates. Thus, it is important to supply an appropriate amount of cooling air. For reference, the on-board injection changes a rotation direction component of the cooling air supplied to the blade, thus is also called swirler.

Referring to FIG. 1, a conventional swirler included in a gas turbine will be described.

Referring to FIG. 1, in the conventional swirler, a plurality of vanes 2 are disposed at a predetermined interval at an outer side of a pre-swirler housing 10. The vane 2 is formed in a streamlined airfoil shape, and movement of the cooling air is guided by passing through the vane 2.

The swirler used as described above has a problem that a flow rate, pressure, and temperature required by the turbine are not stably satisfied. In this case, a structure of the swirler needs to be changed or a structure of the vane 2 needs to be changed to secure safety of the cooling air supplied to the turbine.

### SUMMARY OF THE INVENTION

An object of the present invention is to stabilize a relative temperature of a fluid supplied to a blade by increasing a swirl which is a rotational velocity component of cooling air moving through a pre-swirler of a gas turbine.

Other objects and advantages of the present invention can be understood by the following description, and become apparent with reference to the embodiments of the present invention. Also, it is obvious to those skilled in the art to which the present invention pertains that the objects and advantages of the present invention can be realized by the means as claimed and combinations thereof.

In accordance with one aspect of the present invention, a pre-swirler for a gas turbine includes: a plurality of main vanes spaced apart from each other at a predetermined interval along a circumferential direction of a pre-swirler housing provided in a compressor of the gas turbine; and an auxiliary vane disposed between the main vanes spaced apart from each other and having a size smaller than that of the main vane, in which the main vane includes a first chord length which is a shortest length connecting from a leading edge formed at a tip end portion of a vane body rounded to be streamlined to a trailing edge formed at a rear end portion of the vane body, an intake surface rounded outwardly at an upper surface of the vane body, a pressure surface rounded inwardly at a lower surface of the vane body, a first axial chord formed between the leading edge and the trailing edge, a first stagger angle formed between the first chord length and the first axial chord, and a first turning angle formed between a movement direction in which cooling air passing through the trailing edge moves and a virtual vertical line drawn from the trailing edge.

The main vane may be disposed to be inclined in a tangential direction when viewed at the front of the pre-swirler housing.

When a spacing distance between the main vanes is L, the auxiliary vane may be positioned above a position of L/2.

When a spacing distance between the main vanes is L, the auxiliary vane may be positioned at a position of 3L/5.

The main vane may be disposed to be inclined in a tangential direction when viewed at the front of the pre-swirler housing.

When a spacing distance between the main vanes is L, the auxiliary vane may be positioned above a position of L/2.

When a spacing distance between the main vanes is L, the auxiliary vane may be positioned at a position of 3L/5.

When the first chord length of the main vane connecting from the leading edge to the trailing edge is CL, the auxiliary vane may be positioned at a position of CL/2.

When the first chord length of the main vane connecting from the leading edge to the trailing edge is CL, the auxiliary vane may be positioned at a further back position than a position of CL/2.

When a maximum thickness of the main vane is Tm, the auxiliary vane may be formed to have a thickness of 2Tm/5.

At least one auxiliary vane may be disposed between the main vanes.

A trailing edge of the auxiliary vane may be positioned further inward than a position at which the trailing edge of the main vane is formed.

A span between the main vanes spaced apart from each other may be 70 mm or less.

The first stagger angle of the main vane may be maintained in a range of 50° to 60°.

In accordance with another aspect of the present invention, a pre-swirler for a gas turbine includes: a plurality of main vanes spaced apart from each other at a predetermined interval along a circumferential direction of a pre-swirler housing provided in a compressor of the gas turbine; and an auxiliary vane disposed between the main vanes spaced apart from each other and having a size smaller than that of the main vane, in which the main vane includes a second chord length which is a shortest length connecting from a leading edge formed at a tip end portion of a vane body rounded to be streamlined to a trailing edge formed at a rear end portion of the vane body, an intake surface rounded outwardly at an upper surface of the vane body, a pressure surface rounded inwardly at a lower surface of the vane body, a second axial chord formed between the leading edge and the trailing edge, a second stagger angle formed between the second chord length and the second axial chord, and a second turning angle formed between a movement direction in which cooling air passing through the trailing edge moves and a virtual vertical line drawn from the trailing edge.

The second stagger angle of the auxiliary vane may be maintained in a range of 60° to 70°.

In accordance with still another aspect of the present invention, a pre-swirler for a gas turbine includes: a plurality of first main vanes spaced apart from each other at a predetermined interval along a circumferential direction of a pre-swirler housing provided in a compressor of the gas turbine; a first auxiliary vane disposed between the first main vanes spaced apart from each other and having a size smaller than that of the first main vane; a second main vane positioned between the first main vanes spaced apart from each other; and a second auxiliary vane positioned adjacent to the second main vane and formed to have a size smaller than that of the second main vane, in which the first main vane includes a first chord length which is a shortest length connecting from a leading edge formed at a tip end portion of a vane body rounded to be streamlined to a trailing edge formed at a rear end portion of the vane body, an intake surface rounded outwardly at an upper surface of the vane body, a pressure surface rounded inwardly at a lower surface of the vane body, a first axial chord formed between the leading edge and the trailing edge, a first stagger angle formed between the first chord length and the first axial chord, and a first turning angle formed between a movement direction in which cooling air passing through the trailing edge moves and a virtual vertical line drawn from the trailing edge, and the second auxiliary vane includes a second chord length which is a shortest length connecting from a leading edge formed at a tip end portion of a vane body rounded to be streamlined to a trailing edge formed at a rear end portion of the vane body, an intake surface rounded outwardly at an upper surface of the vane body, a pressure surface rounded inwardly at a lower surface of the vane body, a second axial chord formed between the leading edge and the trailing edge, a second stagger angle formed between the second chord length and the second axial chord, and a second turning angle formed between a movement direction in which cooling air passing through the trailing edge moves and a virtual vertical line drawn from the trailing edge.

When the second chord length is 1, the first chord length may be extended to be 1.5 to 1.56 times longer than the second chord length.

The second axial chord may be extended to a length corresponding to a half of a length of the first axial chord.

The first and second turning angles may maintain the same angle.

The second stagger angle of the second auxiliary vane may be maintained in a range of 60° to 70°.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a perspective view illustrating a conventional swirler;

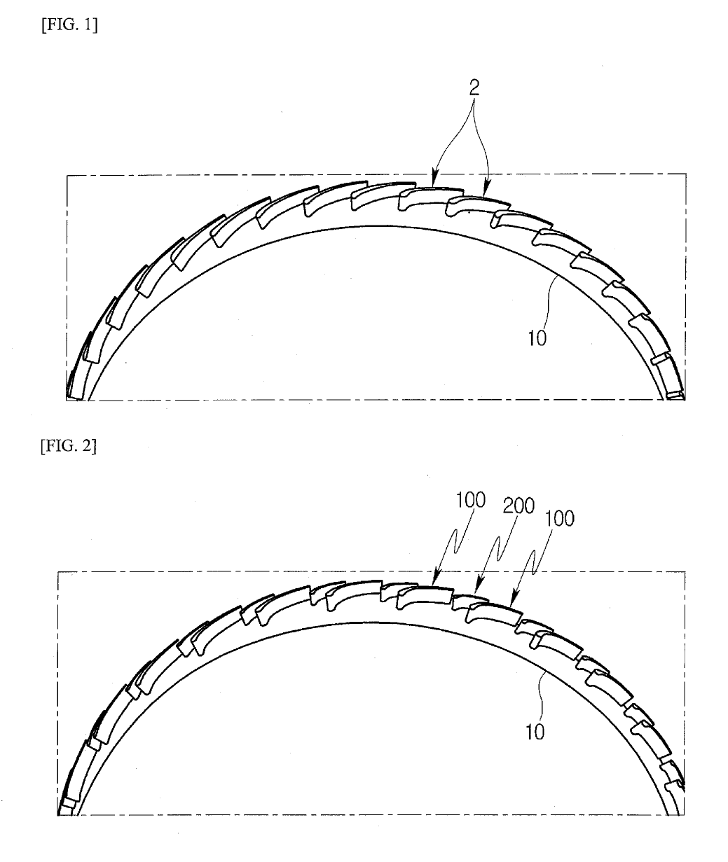

FIG. 2 is a perspective view illustrating a pre-swirler for a gas turbine according to an embodiment of the present invention;

FIG. 3 is a diagram illustrating a main vane and an auxiliary vane according to an embodiment of the present invention;

FIGS. 4 and 5 are diagrams illustrating a main vane according to an embodiment of the present invention;

FIG. 6 is a diagram illustrating an auxiliary vane according to an embodiment of the present invention;

FIG. 7 is a graph illustrating a swirl ratio according to a position of the auxiliary vane according to an embodiment of the present invention;

FIG. 8 is a graph illustrating total pressure loss according to a position of the auxiliary vane according to an embodiment of the present invention;

FIG. 9 is a perspective view illustrating a pre-swirler for a gas turbine according to another embodiment of the present invention;

FIG. 10 is a diagram illustrating first and second main vanes and first and second auxiliary vanes according to another embodiment of the present invention; and

FIG. 11 is a diagram illustrating the second auxiliary vane according to another embodiment of the present invention.

### DESCRIPTION OF SPECIFIC EMBODIMENTS

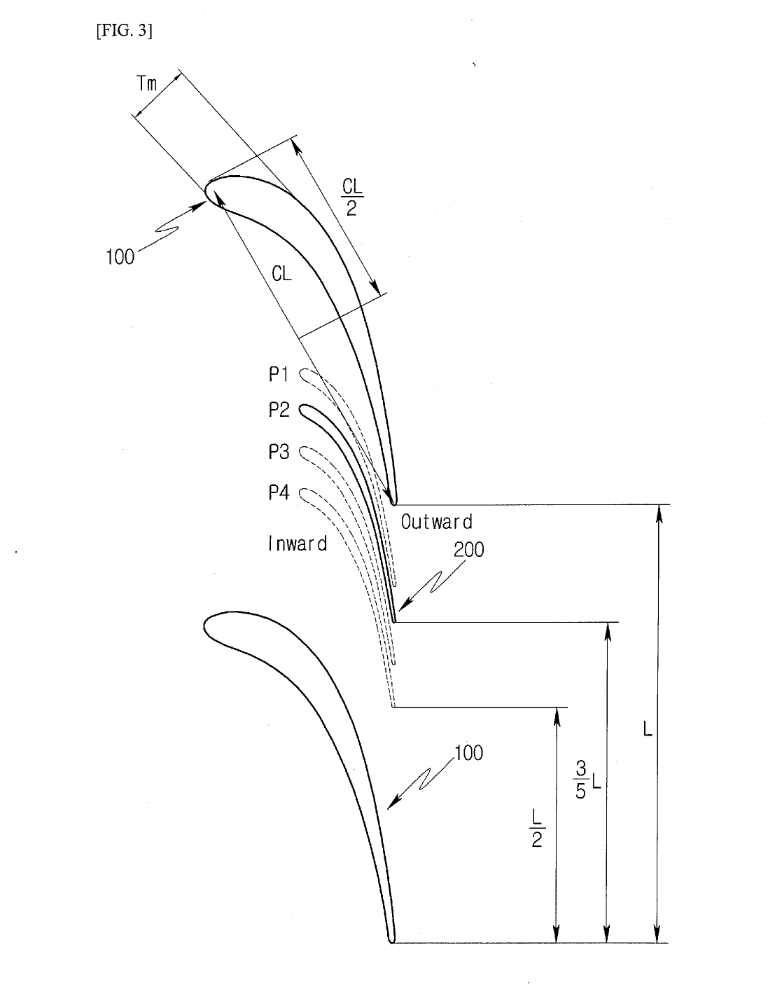

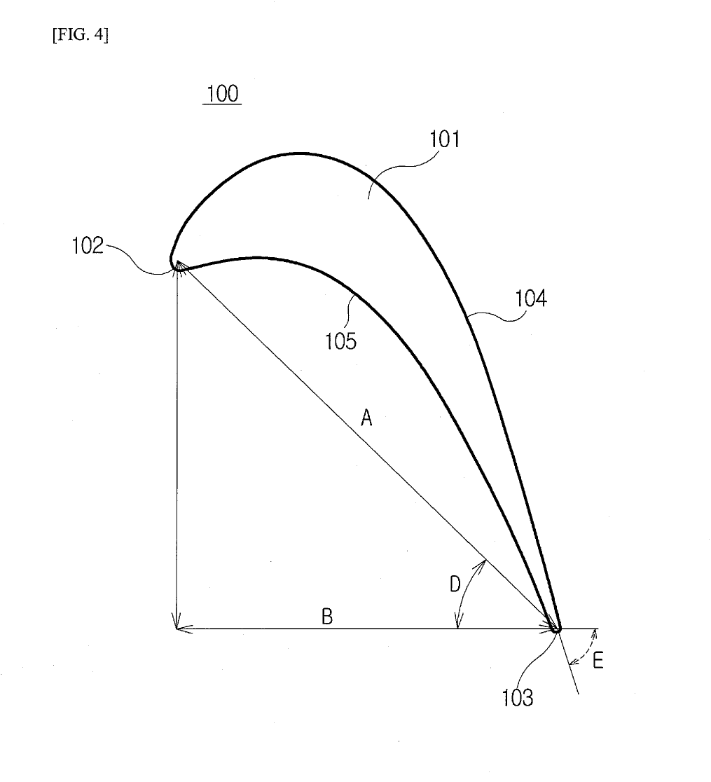

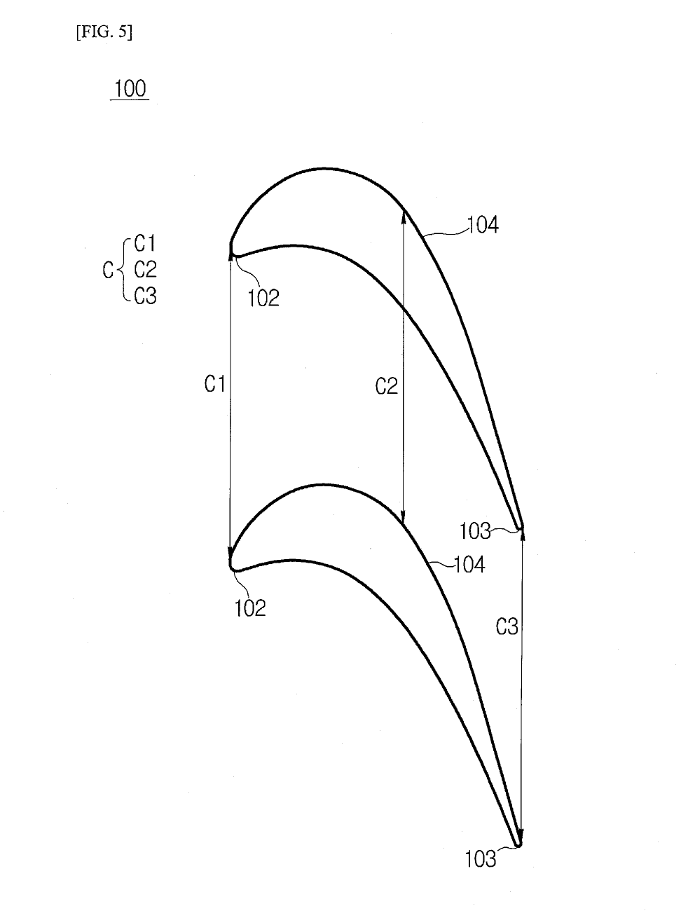

A pre-swirler for a gas turbine according to an embodiment of the present invention will be described with reference to the accompanying drawings. FIG. 2 is a perspective view illustrating a pre-swirler for a gas turbine according to an embodiment of the present invention, FIG. 3 is a diagram illustrating a main vane and an auxiliary vane according to an embodiment of the present invention, and FIGS. 4 and 5 are diagrams illustrating main vanes according to an embodiment of the present invention.

Referring to FIGS. 2 to 5, the pre-swirler for a gas turbine according to a present embodiment is configured as a dual vane type. For example, the pre-swirler for a gas turbine includes a plurality of main vanes 100 spaced apart from each other at a predetermined interval along a circumferential direction of a pre-swirler housing 10 provided in a compressor of the gas turbine, and an auxiliary vane 200 disposed between the main vanes 100 spaced apart from each other and having a size smaller than that of the main vane 100.

The main vane 100 may be formed, for example, in an airfoil shape, and may include a first chord length A which is a shortest length connecting from a leading edge 102 formed at a tip end portion (left side in the drawing) of a vane body 101 to a trailing edge 103 formed at a rear end portion (lower right side in the drawing) thereof. An overall shape of the vane body 101 is rounded to be streamlined from the leading edge 102 to the trailing edge 103.

Further, the main vane 100 includes an intake surface 104 rounded outwardly at an upper surface of the vane body 101, a pressure surface 105 rounded inwardly at a lower surface of the vane body 101, a first axial chord B formed between the leading edge 102 and the trailing edge 103, a first stagger angle D formed between the first chord length A and the first axial chord B, and a first turning angle E formed between a movement direction of the cooling air passing through the trailing edge 103 and a virtual vertical line drawn from the trailing edge 103. Here, the main vane 100 is indicated by a bold line and the virtual vertical line is indicated by a thin line.

The vane body 101 is extended in a shape illustrated in the drawings from the leading edge 102 contacting the cooling air toward the trailing edge 103, and the intake surface 104 and the pressure surface 105 are extended to be rounded as illustrated in the drawings.

The first chord length A means a length from the leading edge 102 to the trailing edge 103, which is indicated by a solid line.

Further, the first axial chord B may be formed when a virtual first vertical line is extended downward from the leading edge 102 and a virtual horizontal line is extended from the trailing edge 103 toward the first vertical line in the drawings.

If the length of the first axial chord B is increased, a position of the trailing edge 103 may be moved to the right in a horizontal direction from the current position, and the shape of the intake surface 104 and the pressure surface 105 described above may be changed as the trailing edge 103 moves.

The drawings as illustrated in FIGS. 2 to 5 represent an optimum shape of the main vane 100. According to an embodiment of the present invention, since the movement direction of the cooling air may be changed according to the length of the first axial chord B, it is preferable that the first axial chord B may be extended in consideration of the plurality of main vanes 100 and the auxiliary vane 200 to be described later.

The first stagger angle D of the main vane 100 may be maintained in a range of 50° to 60°. As an example, the first stagger angle D may be 58°, and the first turning angle E may be 80° or more.

The plurality of main vanes 100 are disposed at a predetermined interval in the circumferential direction of the pre-swirler housing 10, and the main vanes 100 maintain a span C therebetween.

The span C may further include a first span C1 between the leading edges of the main vane 100 spaced apart from each other, a second span C2 between the intake surfaces 104 of the main vane 100 spaced apart from each other, and a third span C3 between the trailing edges 103 of the main vanes 100 spaced apart from each other are maintained.

The span C serves as a passage through which the cooling air moves, and in the present embodiment, the span illustrated in the drawings is maintained in consideration of a position of the main vane 100 with respect to the auxiliary vane 200 and an interval between the main vane 100 and the auxiliary vane 200.

The span between the main vanes 100 spaced apart from each other according to the present embodiment may be maintained to be 70 mm or less, and as a swirl value is increased in a rotation direction of the cooling air, unnecessary flow caused by secondary flow loss can be minimized, thereby maintaining stable movement of the cooling air.

The first stagger angle D of the main vane 100 may be maintained in a range of 50° to 60°. As an example, the first stagger angle D may be 58°, and the first turning angle E may be 80° or more.

When a spacing distance between the main vanes 100 is L, the auxiliary vane 200 may be positioned at a position of L/2. According to simulation results of the cooling air movement, the position may minimize pressure loss at an inlet where the main vane 100 is positioned, and minimize unnecessary secondary flow loss of the cooling air. For reference, the spacing distance L corresponds to a length measured based on the trailing edges of the main vanes 100 spaced apart from each other.

The auxiliary vane positioned between the main vanes 100 facing each other illustrated in FIG. 3 may be disposed at four positions. A first position indicates an auxiliary vane positioned at a P1 position illustrated in FIG. 3, a second position indicates an auxiliary vane positioned at a P2 position, a third position indicates an auxiliary vane positioned at a P3 position, and a fourth position indicates an auxiliary vane positioned at a P4 position.

For reference, an optimum position of the auxiliary vane 200 according to the present embodiment corresponds to the P2 position indicated by a solid line. The auxiliary vanes may be positioned at different positions other than the P2 position.

Further, although it is most preferable that the auxiliary vane 200 is positioned at the P2 position as the optimum position, the auxiliary vane 200 may be positioned at the P3 position, or may be positioned at both P2 and P3 positions.

In the case in which the auxiliary vane 200 is positioned between the main vanes 100, it is possible to decrease movement of the fluid stopping the movement of the cooling air, and minimize unnecessary flow caused by secondary flow loss while the cooling air moves to the auxiliary vane 200 by passing through the main vane 100, thereby maintaining stable movement of the cooling air.

According to an embodiment of the present invention, when a spacing distance between the main vanes 100 is L, the auxiliary vane 200 is positioned at a position of 3L/5, based on the P2 position, in order to maintain the above-described operational effects. The position at 3L/5 may be an optimum position for the auxiliary vane 200 along with the above-described position of L/2.

The position is a position moved toward the P3 position at an upper side in FIG. 3 based on the auxiliary vane positioned at the P4 position by a length corresponding to 5% of a length corresponding to L/2, and the P2 position is placed upward by a length corresponding to 10% based on the auxiliary vane positioned at the P4 position.

According to the present embodiment, when the first chord length A connecting from the leading edge 102 to the trailing edge 103 is CL, the auxiliary vane is positioned at a position of CL/2.

The position may correspond to an optimum position when the auxiliary vane 200 is positioned between the main vanes 100, and corresponds to a position at which the auxiliary vane 200 positioned between the main vanes 100 may stably guide movement of the cooling air while minimizing the problem caused by secondary flow loss.

According to the present embodiment, when the first chord length connecting from the leading edge 102 to the trailing edge 103 is CL, the auxiliary vane may be positioned at a further back position than the position of CL/2.

The position corresponds to an optimum position when the auxiliary vane 200 is positioned between the main vanes 100, and corresponds to a position at which the auxiliary vane 200 may stably guide movement of the cooling air and minimize the problem caused by secondary flow loss.

The auxiliary vane 200 is formed to have a thickness thinner than a maximum thickness of the main vane 100. For example, when the maximum thickness of the main vane 100 is Tm, the auxiliary vane 200 is formed to have a thickness of 2Tm/5. The thickness of the auxiliary vane 200 may be changed depending on the thickness of the main vane 100.

At least one auxiliary vane 200 according to the present embodiment is disposed between the main vanes 100, preferably at the above-described position. However, a plurality of auxiliary vanes may be disposed according to an embodiment of the present invention.

The trailing edge 203 of the auxiliary vane 200 may be positioned further inward than the position at which the trailing edge 103 of the main vane 100 is formed.

The auxiliary vane 200 is provided to stably guide movement of the cooling air introduced through a space between the main vanes 100. Therefore, the trailing edge 203 of the auxiliary vane 200 may be positioned further inward than the position of the trailing edge 103 of the main vane 100 than that the trailing edge 203 of the auxiliary vane 200 is positioned further outward than the position of the trailing edge 103 of the main vane 100, in terms of maintaining safety of the cooling air.

The cooling air moves along the intake surface 104 and the pressure surface 105 of the main vane 100, and then is separated at the position of the trailing edge 103 to move in the movement direction. The trailing edge 203 of the auxiliary vane 200 is positioned at the above-described position to facilitate the movement of the cooling air at the position of the trailing edge 103.

The main vane 100 may be disposed such that is inclined in a tangential direction when viewed at the front of the pre-swirler housing 10, and in this case, when moving along the main vane 100, movement safety of the cooling air may be improved, and a vortex generation can be minimized.

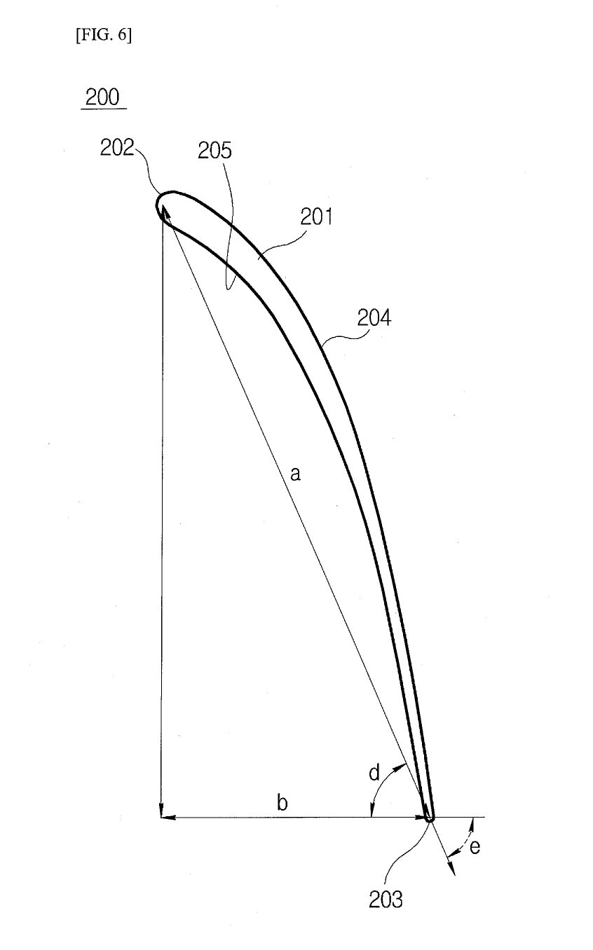

Referring to FIG. 6, an auxiliary vane 200 according to embodiment of the present disclosure is positioned between a plurality of main vanes 100 spaced apart from each other at a predetermined interval along a circumferential direction of a pre-swirler housing 10 provided in a compressor of the gas turbine.

Further, a second chord length a which is a shortest length connecting from a leading edge 202 formed at a tip end portion of a vane body 201 to a trailing edge 203 formed at a rear end portion thereof, an intake surface 204 rounded outwardly at an upper surface of the vane body 201, and a pressure surface rounded inwardly at a lower surface of the vane body 201 are formed in the auxiliary vane 200.

Further, the auxiliary vane 200 includes a second axial chord b which can be defined as a horizontal length between the leading edge 202 and the trailing edge 203, a second stagger angle d formed between the second chord length a and the second axial chord b, and a second turning angle e formed between a movement direction of the cooling air passing through the trailing edge 203 and a virtual vertical line drawn from the trailing edge 203.

The vane body 201 is extended in a shape illustrated in the drawings from the leading edge 202 contacting the cooling air toward the trailing edge 203, and the intake surface 204 and the pressure surface 205 are extended to be rounded as illustrated in the drawings.

The second chord length a means a length from the leading edge 202 to the trailing edge 203, which is indicated by a solid line.

Further, the second axial chord b may be formed when a virtual first vertical line is extended downward from the leading edge 202 and a virtual horizontal line is extended from the trailing edge 203 toward the first vertical line in the drawings.

If the length of the second axial chord b is increased, a position of the trailing edge 203 may be moved to the right in a horizontal direction from the current position, and the shape of the intake surface 204 and the pressure surface 205 described above may be changed as the trailing edge 203 moves.

Since the movement direction of the cooling air is changed according to the length of the second axial chord b, the second axial chord b may be extended in the form illustrated in the drawings.

The second stagger angle d of the auxiliary vane 200 is maintained in a range of 60° to 70°, and the angle is maintained in the above range in consideration of a disposition relationship between the main vane 100 and the auxiliary vane 200.

In this case, while the cooling air moves by passing through the auxiliary vane 200, unnecessary flow caused by secondary flow loss can be minimized, thereby maintaining stable movement of the cooling air.

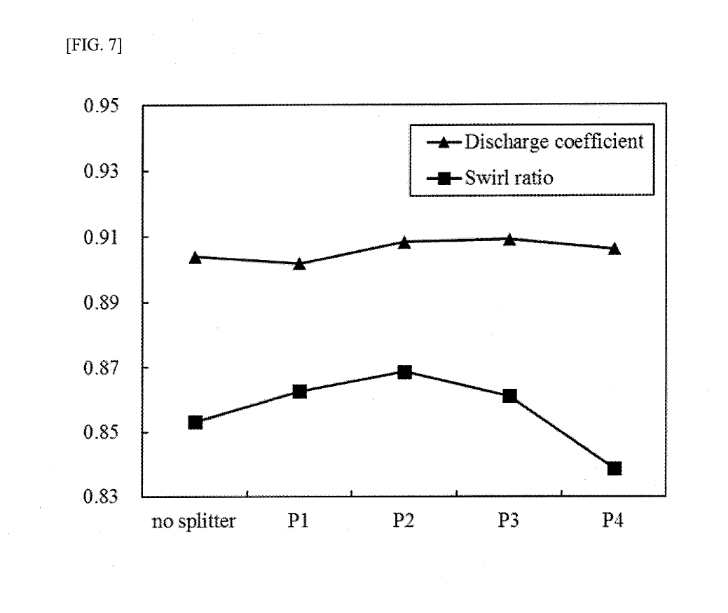

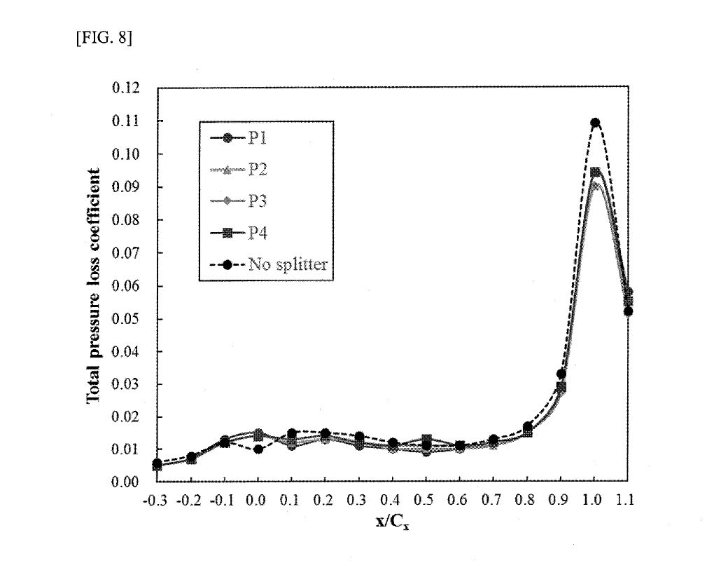

FIG. 7 is a graph illustrating a swirl ratio according to a position of the auxiliary vane according to an embodiment of the present invention, and FIG. 8 is a graph illustrating total pressure loss according to a position of the auxiliary vane. The auxiliary vane positioned between the main vanes facing each other as illustrated in FIG. 3 may be disposed at four positions. P1 indicates the auxiliary vane positioned at the P1 position, P2 indicates the auxiliary vane positioned at the P2 position, P3 indicates the auxiliary vane positioned at the P3 position, and P4 indicates the auxiliary vane positioned at the P4 position.

Referring to FIGS. 7 and 8, the auxiliary vane 200 according to an embodiment of the present invention may be positioned at one or two of the P1 to P4 positions, as illustrated in FIG. 3.

When comparing swirl ratios of the auxiliary vanes 200 disposed at the four positions as described above, it may be appreciated that the auxiliary vane 200 positioned at the P2 position has the best swirl ratio. The auxiliary vanes positioned at the P1 position and the P3 position have the second best swirl ratio. A discharge coefficient is also illustrated in FIG. 7.

Referring to FIG. 8, total pressure loss in the auxiliary vane 200 is depicted according to the P1 position to the P4 position, and it may be appreciated that although the total pressure loss is changed according to the P1 position to the P4 position, the total pressure loss is decreased when the auxiliary vane 200 is provided.

A pre-swirler for a gas turbine according to another embodiment of the present invention will be described with reference to the accompanying drawings.

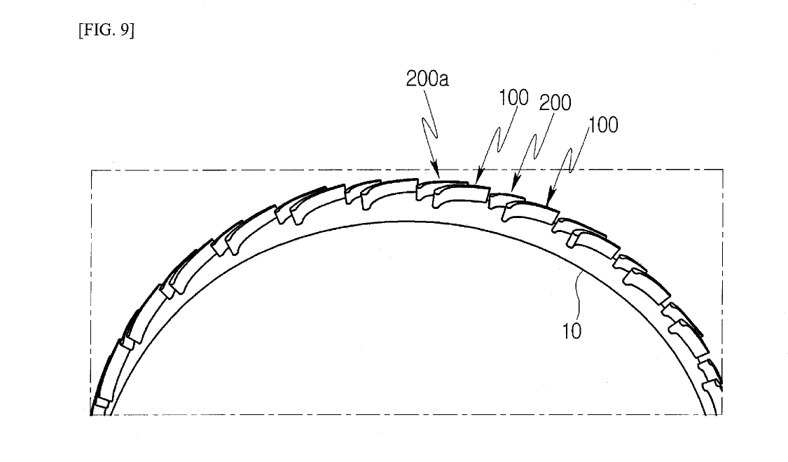

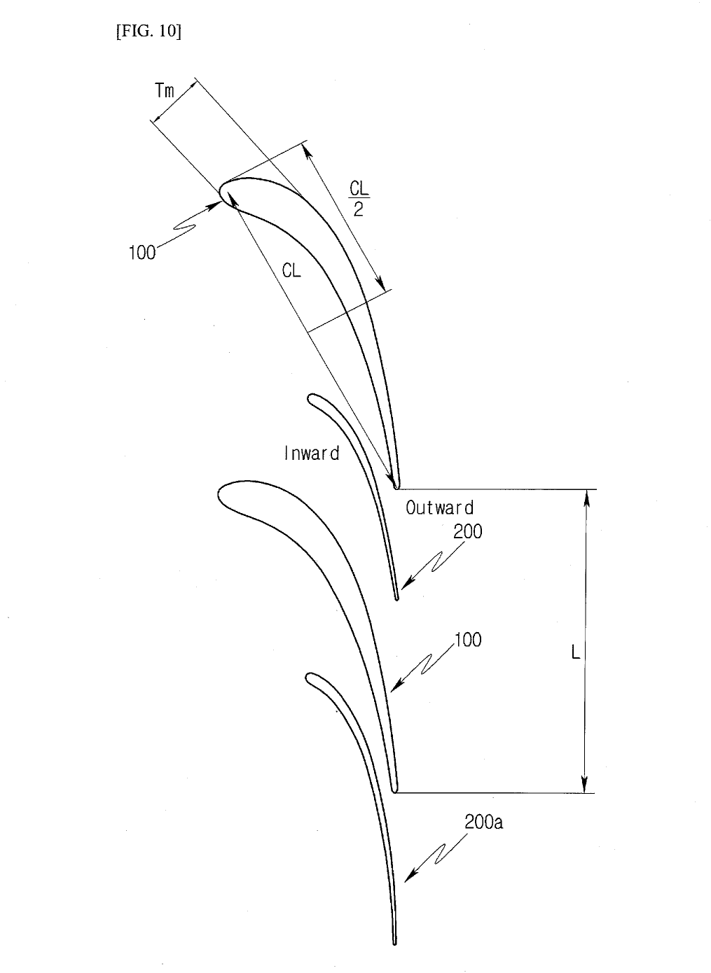

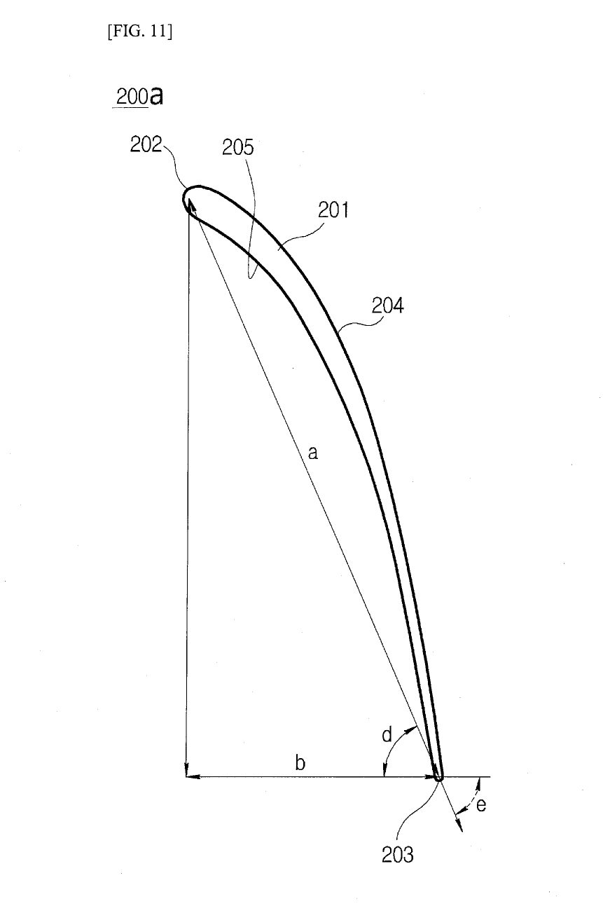

Referring to FIGS. 9 to 11, unlike the aforementioned embodiment, a first main vane 100 and a first auxiliary vane 200 are disposed in a circumferential direction of a pre-swirler housing 10, and the first main vane 100 and the first auxiliary vane 200 spaced apart from each other are disposed in pair, and adjacently thereto, a second main vane 100 and a second auxiliary vane 200a are disposed in pair. Further, the disposition relationship is alternately repeated in the circumferential direction of the pre-swirler housing 10.

In the case of the disposition relationship as described above, stability of guiding the cooling air movement may be improved, and the loss may be decreased, such that unnecessary flow caused by secondary flow loss may be minimized, resulting in the stable movement of the cooling air.

To this end, the first main vane 100 is forming, for example, in an airfoil shape, and includes a first code length A which is a shortest length connecting from a leading edge 102 formed at a tip end portion (left side in the drawing) of a vane body 101 (see FIG. 4) to a trailing edge 103 formed at a rear end portion (lower right side in the drawing) thereof. An overall shape of the vane body 101 is rounded to be streamlined from the leading edge 102 to the trailing edge.

Further, in a similar manner in FIG. 4, the main vane 100 includes an intake surface 104 rounded outwardly at an upper surface of the vane body 101, a pressure surface rounded inwardly at a lower surface of the vane body 101, a first axial chord B formed between the leading edge 102 and the trailing edge 103, a first stagger angle D formed between the first chord length A and the first axial chord B, and a first turning angle E formed between a movement direction of the cooling air passing through the trailing edge 103 and a virtual vertical line drawn from the trailing edge 103. Here, the first main vane 100 is indicated by a bold line and the virtual vertical line is indicated by a thin line.

The vane body 101 is extended in a shape illustrated in the drawings from the leading edge 102 contacting the cooling air toward the trailing edge 103, and the intake surface 104 and the pressure surface 105 are extended to be rounded as illustrated in the drawings.

The first chord length A means a length from the leading edge 102 to the trailing edge 103, which is indicated by a solid line.

Further, the first axial chord B may be formed when a virtual first vertical line is extended downward from the leading edge 102 and a virtual horizontal line is extended from the trailing edge 103 toward the first vertical line in the drawings. The first axial chord B may be the horizontal length between the virtual first vertical lines extended downward from the leading edge 102 and the trailing edge 103.

If the length of the first axial chord B is increased, a position of the trailing edge 103 may be moved to the right in a horizontal direction from the current position, and the shape of the intake surface 104 and the pressure surface 105 described above may be changed as the trailing edge 103 moves.

Since the movement direction of the cooling air may be changed according to the length of the first axial chord B, the first axial chord B may be extended in the form illustrated in the drawings in consideration of the plurality of first main vanes 100 and the first auxiliary vane 200 to be described later.

The first stagger angle D of the first main vane 100 is maintained in a range of 50° to 60°. As an example, the first stagger angle D may be 58°, and the first turning angle E may be 80° or more.

When a spacing distance between the first main vanes 100 is L, a position of the first auxiliary vane 200 is at a position of L/2. According to the simulation results of the cooling air movement, the position may minimize pressure loss at an inlet where the first main vane 100 is positioned, and minimize unnecessary secondary flow loss of the cooling air. The spacing distance L corresponds to a length measured based on the trailing edges of the first main vanes 100 spaced apart from each other.

An optimum position of the first auxiliary vane 200 according to the present embodiment corresponds to the position indicated by a solid line. The first auxiliary vane 200 may also be positioned at different positions other than the position.

In the case in which the first auxiliary vane 200 is positioned between the first main vanes 100, it is possible to decrease the movement of the fluid stopping the movement of the cooling air, and minimize unnecessary flow caused by secondary flow loss while the cooling air moves to the first auxiliary vane 200 by passing through the first main vane 100, thereby maintaining stable movement of the cooling air.

According to an embodiment of the present invention, when the first chord length A connecting from the leading edge 102 to the trailing edge 103 is CL, the auxiliary vane is positioned at a position of CL/2.

The position may correspond to an optimum position when the first auxiliary vane 200 is positioned between the first main vanes 100, and corresponds to a position at which the first auxiliary vane 200 positioned between the first main vanes 100 may stably guide movement of the cooling air and minimize the problem caused by secondary flow loss.

When the first chord length connecting from the leading edge 102 to the trailing edge 103 is CL, the auxiliary vane may be positioned at a further back position than the position of CL/2.

The first auxiliary vane 200 is formed to have a thickness thinner than a maximum thickness of the first main vane 100. For example, when the maximum thickness of the first main vane 100 is Tm, the first auxiliary vane 200 is formed to have a thickness of 2Tm/5. The thickness of the first auxiliary vane 200 may be changed depending on the thickness of the first main vane 100.

At least one first auxiliary vane 200 according to the present embodiment is disposed between the first main vanes 100. Most preferably, one first auxiliary vane 200 is disposed at the above-described position. However, in some cases, a plurality of first auxiliary vanes may be disposed.

In addition, the trailing edge 203 of the first auxiliary vane 200 may be positioned further inward than the position at which the trailing edge 103 of the first main vane 100 is formed.

The first auxiliary vane 200 is provided to stably guide movement of the cooling air introduced through a space between the first main vanes 100. Therefore, it is desirable that the position of the trailing edge 203 of the first auxiliary vane 200 is positioned further inward than the position of the trailing edge 103 of the first main vane 100 than that the position of the trailing edge 203 of the first auxiliary vane 200 is positioned further outward than the position of the trailing edge 103 of the first main vane 100, in terms of maintaining safety of the cooling air.

The cooling air moves along the intake surface 104 and the pressure surface 105 of the first main vane 100, and then is separated at the position of the trailing edge 103 to move in the movement direction. The trailing edge 203 of the first auxiliary vane 200 is positioned at the above-described position to facilitate the movement of the cooling air at the position of the trailing edge 103.

The first main vane 100 may be disposed such that the first main vane 100 is inclined in a tangential direction when viewed at the front of the pre-swirler housing 10, and in this case, when moving along the first main vane 100, movement safety of the cooling air may be improved, and unnecessary generation of a vortex may be minimized.

Referring to FIGS. 9 to 11, the second auxiliary vane 200a according to an embodiment of the present invention is positioned adjacent to a plurality of second main vanes 100 spaced apart from each other along the circumferential direction of the pre-swirler housing 10 provided in a compressor of the gas turbine. The second auxiliary vane 200a is formed to have a size smaller than that of the second main vane 100. A configuration of the second main vane 100 is the same as that of the first main vane 100, thus detailed description therefor will be omitted.

Further, a second chord length a which is a shortest length connecting from a leading edge 202 formed at a tip end portion of a vane body 201 to a trailing edge 203 formed at a rear end portion thereof, an intake surface 204 rounded outwardly at an upper surface of the vane body 201, and a pressure surface rounded inwardly at a lower surface of the vane body 201 are formed.

Further, the second auxiliary vane 200a includes a second axial chord b formed between the leading edge 202 and the trailing edge 203, a second stagger angle d formed between the second chord length a and the second axial chord b, and a second turning angle e formed between the movement direction of the cooling air passing through the trailing edge 203 and a virtual vertical line drawn from the trailing edge 203.

The vane body 201 is extended in a shape illustrated in the drawings from the leading edge 202 contacting the cooling air toward the trailing edge 203, and the intake surface 204 and the pressure surface 205 are extended to be rounded as illustrated in the drawings.

The second chord length a means a length from the leading edge 202 to the trailing edge 203, which is indicated by a solid line.

Further, the second axial chord b may be formed when a virtual first vertical line is extended downward from the leading edge 202 and a virtual horizontal line is extended from the trailing edge 203 toward the first vertical line in the drawings.

If the length of the second axial chord b is increased, a position of the trailing edge 203 may be moved to the right in a horizontal direction from the current position, and the shape of the intake surface 204 and the pressure surface 205 described above may be changed as the trailing edge 203 moves.

Since the movement direction of the cooling air is changed according to the length of the second axial chord b, it is preferable that the second axial chord b is extended in the form illustrated in the drawings.

When the second chord length a of the second auxiliary vane 200a is 1, the first chord length A of the main vane 100 is extended to be 1.5 to 1.56 times longer than the second chord length a. In consideration of a size of the main vane 100 and a size of the second auxiliary vane 200a, respectively, the ratio described above is maintained to minimize unnecessary flow caused by secondary flow loss and maintain stable movement of the cooling air.

The second axial chord b of the second auxiliary vane 200a is extended to a length corresponding to a half of the first axial chord B of the main vane 100. The second axial chord b becomes smaller in proportion to the size of the second auxiliary vane 200a, and according to the present embodiment, the second axial chord b is extended to a length of ½ of the first axial chord B of the main vane 100.

In this case, the ratio is maintained in order to minimize the unnecessary flow caused by secondary flow loss that may occur due to the movement of the cooling air and to maintain stable movement of the cooling air.

The second stagger angle d of the second auxiliary vane 200a is maintained in a range of 60° to 70°, and the angle is maintained in the above range in consideration of a disposition relationship between the main vane 100 and the second auxiliary vane 200a.

In this case, while the cooling air moves by passing through the second auxiliary vane 200a, the unnecessary flow caused by secondary flow loss may be minimized, thereby maintaining stable movement of the cooling air.

The first turning angle E of the main vane 100 and the second turning angle e of the second auxiliary vane 200a according to an embodiment of the present invention may be identical. The first and second turning angles E and e each determine a movement direction of the cooling air after passing through the main vane 100 and the second auxiliary vane 200a, and when the main vane 100 and the second auxiliary vane 200a have the same angle, the movement directions of the cooling air coincide with each other.

The cooling air moves along the surfaces of the main vane 100 and the second auxiliary vane 200a, and when the first and second turning angles E and e are equal to each other, secondary loss of the cooling air or loss caused by a vortex generation may be minimized, and movement may be stably guided.

According to the embodiments of the present invention, it is possible to change swirling of cooling air supplied to the blade by increasing a swirl value which is a rotational velocity component of the cooling air moving through the pre-swirler of the gas turbine and maintain stable movement of the cooling air by decreasing flow resistance of the cooling air passing through the main vane and the auxiliary vane.

According to the embodiments of the present invention, it is possible to minimize unnecessary flow caused by secondary flow loss of the cooling air passing through the per-swirler and minimize unnecessary generation of a vortex.

What is claimed is:

1. A pre-swirler for a gas turbine, comprising:
a plurality of main vanes spaced apart from each other at a predetermined interval along a circumferential direction of a pre-swirler housing provided in a compressor of the gas turbine; and
an auxiliary vane disposed between the main vanes spaced apart from each other and having a size smaller than that of the main vane,
wherein the main vane includes a first chord length which is a shortest length connecting from a leading edge formed at a tip end portion of a vane body to a trailing edge formed at a rear end portion of the vane body, an intake surface rounded outwardly at an upper surface of the vane body, a pressure surface rounded inwardly at a lower surface of the vane body, a first axial chord formed between the leading edge and the trailing edge, a first stagger angle formed between the first chord length and the first axial chord, and a first turning angle formed between a movement direction of cooling air passing through the trailing edge and a virtual vertical line drawn from the trailing edge.

2. The pre-swirler for a gas turbine of claim 1, wherein the main vane is inclined in a tangential direction when viewed at the front of the pre-swirler housing.

3. The pre-swirler for a gas turbine of claim 1, wherein when a spacing distance between the main vanes is L, the auxiliary vane is positioned at a position of L/2.

4. The pre-swirler for a gas turbine of claim 1, wherein when a spacing distance between the main vanes is L, the auxiliary vane is positioned at a position of 3 L/5.

5. The pre-swirler for a gas turbine of claim 1, wherein when the first chord length of the main vane connecting from the leading edge to the trailing edge is CL, the auxiliary vane is positioned at a position of CL/2.

6. The pre-swirler for a gas turbine of claim 1, wherein when the first chord length of the main vane connecting from the leading edge to the trailing edge is CL, the auxiliary vane is positioned at a further back position than a position of CL/2.

7. The pre-swirler for a gas turbine of claim 1, wherein when a maximum thickness of the main vane is Tm, the auxiliary vane is formed to have a thickness of 2Tm/5.

8. The pre-swirler for a gas turbine of claim 1, wherein at least one auxiliary vane is disposed between the main vanes.

9. The pre-swirler for a gas turbine of claim 1, wherein a trailing edge of the auxiliary vane is positioned further inward than a position at which the trailing edge of the main vane is formed.

10. The pre-swirler for a gas turbine of claim 1, wherein a span between the main vanes spaced apart from each other is 70 mm or less.

11. The pre-swirler for a gas turbine of claim 1, wherein the first stagger angle of the main vane is maintained in a range of 50° to 60°.

12. A pre-swirler for a gas turbine, comprising:
a plurality of main vanes spaced apart from each other at a predetermined interval along a circumferential direction of a pre-swirler housing provided in a compressor of the gas turbine; and
an auxiliary vane disposed between the main vanes spaced apart from each other and having a size smaller than that of the main vane,
wherein the auxiliary vane includes a second chord length which is a shortest length connecting from a leading edge formed at a tip end portion of a vane body to a trailing edge formed at a rear end portion of the vane body, an intake surface rounded outwardly at an upper surface of the vane body, a pressure surface rounded inwardly at a lower surface of the vane body, a second axial chord formed between the leading edge and the trailing edge, a second stagger angle formed between the second chord length and the second axial chord, and a second turning angle formed between a movement direction of cooling air passing through the trailing edge and a virtual vertical line drawn from the trailing edge.

13. The pre-swirler for a gas turbine of claim 12, wherein the second stagger angle of the auxiliary vane is maintained in a range of 60° to 70°.

14. A pre-swirler for a gas turbine, comprising:
a plurality of first main vanes spaced apart from each other at a predetermined interval along a circumferential direction of a pre-swirler housing provided in a compressor of the gas turbine;
a first auxiliary vane disposed between the first main vanes spaced apart from each other and having a size smaller than that of the first main vane;
a second main vane positioned between the first main vanes spaced apart from each other; and
a second auxiliary vane positioned adjacent to the second main vane and formed to have a size smaller than that of the second main vane,
wherein the first main vane includes a first chord length which is a shortest length connecting from a leading edge formed at a tip end portion of a vane body to a trailing edge formed at a rear end portion of the vane body, an intake surface rounded outwardly at an upper surface of the vane body, a pressure surface rounded inwardly at a lower surface of the vane body, a first axial chord formed between the leading edge and the trailing edge, a first stagger angle formed between the first chord length and the first axial chord, and a first turning angle formed between a movement direction of cooling air passing through the trailing edge and a virtual vertical line drawn from the trailing edge, and
the second auxiliary vane includes a second chord length which is a shortest length connecting from a leading edge formed at a tip end portion of a vane body to a trailing edge formed at a rear end portion of the vane body, an intake surface rounded outwardly at an upper surface of the vane body, a pressure surface rounded inwardly at a lower surface of the vane body, a second axial chord formed between the leading edge and the trailing edge, a second stagger angle formed between the second chord length and the second axial chord, and a second turning angle formed between a movement direction of cooling air passing through the trailing edge and a virtual vertical line drawn from the trailing edge.

15. The pre-swirler for a gas turbine of claim 14, wherein the first chord length is extended to be 1.5 to 1.56 times longer than the second chord length.

16. The pre-swirler for a gas turbine of claim 14, wherein the second axial chord is extended to a length corresponding to a half of a length of the first axial chord.

17. The pre-swirler for a gas turbine of claim 14, wherein the first and second turning angles are equal to each other.

18. The pre-swirler for a gas turbine of claim 14, wherein the second stagger angle of the second auxiliary vane is maintained in a range of 60° to 70°.
